(19) United States
(12) Patent Application Publication
(10) Pub. No.: US 2010/0268652 A1
(43) Pub. Date: Oct. 21, 2010

(54) APPARATUS AND METHOD FOR CONFIGURING A WORKFLOW

(75) Inventor: Shaoyan Hu, Singapore (SG)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/692,921

(22) Filed: Jan. 25, 2010

(30) Foreign Application Priority Data
Apr. 15, 2009 (SG) 200902584-2

(51) Int. Cl. G06Q 10/00; G06F 3/048

(52) U.S. Cl. 705/301; 715/853

(57) ABSTRACT

An apparatus for configuring a workflow, the workflow comprising at least one activity. The apparatus comprises a template editor for creating or editing a template of an activity implementation for the activity, wherein the template comprises computer-readable instructions and at least one editable variable.

### FIELD OF THE INVENTION

The invention relates to an apparatus and method for configuring a workflow and particularly, though not exclusively, relates to configuring a workflow for enterprise business collaboration.

### BACKGROUND

An enterprise business collaboration typically comprises a number of activities making up a workflow in a corporation. The activities may involve different departments of the corporation and may also include external parties. The resulting workflow is often a complex one. The workflow may be associated with a schedule, while each activity may comprise more than one task and/or a plurality of human-to-human or human-to-computer interaction points. Complex workflows are usually carried out by a combination of resources that often includes computers or clusters of computers and associated software applications, as well as other apparatus and devices that may be controlled by the computers.

For successful performance of the workflow by the combination of resources, the workflow needs to be appropriately configured. Configuring the workflow normally includes appropriately sequencing the activities making up the workflow and incorporating other relevant data or information associated with or required by the workflow. This is normally done using a workflow builder application, through a computer-enabled graphical user interface.

Configuring the workflow also requires an implementation for each activity involved in the workflow to be provided. One way of providing the implementation for each activity is to have a developer create the implementation by writing computer-readable instructions such as specific programme codes or scripts suitable for appropriate resources to perform the various tasks associated with that activity. This provides a flexible way of implementing any activity since the developer can write different codes or scripts suitable for performing any task that each resource is capable of performing. After an activity has been implemented, it can then be properly integrated with the workflow.

When writing computer-readable instructions for implementing an activity, the developer creates a specific logic for that activity while ensuring that all other necessary factors or variables involved with that activity, such as network protocol settings, database connection settings, formula coefficients and any other relevant data or information are also defined in the programme. Considering that a single workflow can comprise a great number of activities, configuring the workflow can therefore be a time-consuming, repetitive and laborious process since the developer or developers have to individually create a specific implementation for every activity in the workflow, even for activities that are similar.

In an attempt to simplify the workflow configuration process, a common practice is for workflow software providers to include a library of activity implementations with their proprietary workflow builder applications so that purchasers of the workflow software have some basic activity implementations to begin with. However, the number of implementations that come with the software is limited and only confined to simple, commonly used activities. Activities that cannot be found in the library therefore still have to be individually implemented by writing programme codes or scripts from scratch. Some workflow software products permit existing activity implementations in the library to be customized or altered by end-user developers. However, the developer would require in-depth programming knowledge of the specific workflow software product in order to alter the programming of an existing activity implementation in the library. This makes the customization process a difficult one that few have the ability to do.

### SUMMARY OF THE INVENTION

According to a first exemplary aspect, there is provided an apparatus for configuring a workflow, the workflow comprising at least one activity. The apparatus comprises a template editor for creating or editing a template of an activity implementation for the activity, wherein the template comprises computer-readable instructions and at least one editable variable.

The apparatus may comprise an activity defining module for defining the at least one variable in order to define the activity implementation.

The apparatus may comprise a template repository for storing the template therein and for retrieving the template therefrom. The apparatus may also comprise a template manager for a user to store a newly created template in the template repository, to view existing templates in the template repository and to retrieve a selected template from the template repository.

The apparatus may comprise an execution module for executing the workflow.

The apparatus may comprise at least one user console for providing access to the template editor and to the activity defining module.

According to a second exemplary aspect, there is provided a method of configuring a workflow, the workflow comprising at least one activity. The method comprises creating or editing a template of an activity implementation for the at least one activity using a template editor in an apparatus for configuring a workflow, wherein the template may comprise computer-readable instructions and at least one editable variable.

The method may comprise checking a template repository in the apparatus for an existing template prior to creating the template, and storing the created template in the template repository. The method may further comprise checking an activity implementation library in the apparatus for an existing activity implementation prior to checking the template repository.

The method may comprise defining the at least one variable using an activity defining module in the apparatus, and storing the activity implementation definition in an activity implementation library. Defining the at least one variable may comprise entering an appropriate value for the variable in a dialogue box of the activity defining module.

The method may comprise executing the workflow using an execution module in the apparatus.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the drawings:

FIG. 1 is a schematic illustration of an exemplary workflow;

FIG. 2 is an architecture diagram of an exemplary apparatus for configuring a workflow;

FIG. 3 is a schematic view of an exemplary dialogue box of an activity defining module of the exemplary apparatus of FIG. 2; and

FIG. 4 is a flow chart of an exemplary method of configuring a workflow.

### DETAILED DESCRIPTION OF THE EXEMPLARY EMBODIMENTS

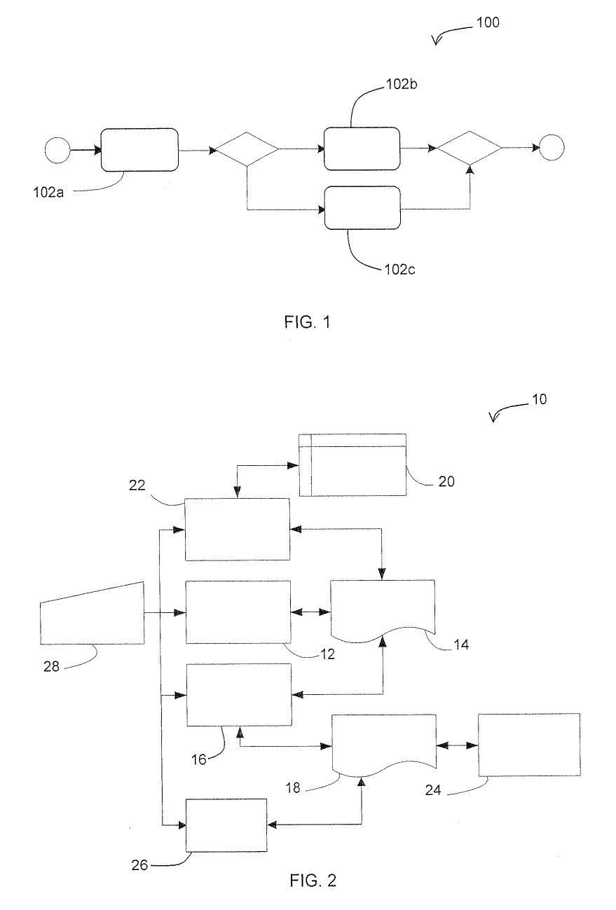

FIG. 2 shows an exemplary apparatus 10 for configuring an exemplary workflow shown in FIG. 1. The exemplary workflow 100 comprises a sequence of activities 102a, 102b, 102c. Each activity 102 is defined by its own unique activity implementation comprising computer-readable instructions. For example, the activity 102a may be for a server to send some information over an intranet or local area network to a task dispatching system at a plant site so that operators at the plant will carry out certain actions as instructed. This activity 102a may be quite complex, involving variables such as communication protocol settings and security setting that may change from time to time and vary from plant to plant.

The apparatus 10 may be a workflow builder software product. The apparatus 10 comprises a template editor 12 for creating or editing a template 14 of the activity implementation for each activity 102. The template 14 comprises computer-readable instructions, and at least one editable variable for subsequent definition to define a specific activity implementation 18. The template editor 12 is preferably a text editor that a developer uses to write programme codes or scripts that make up the computer-readable instructions and the editable variables in the template 14. The template editor 12 preferably includes user-friendly features such as auto-completion, grammar highlighting and syntax checking.

Preferably, the apparatus 10 recognises common scripting or programming languages such as VB Script, Java Script, C#, and VB.Net used with the template editor 12 so that a developer can use standard semantics to create or edit templates 14. This removes the need for developers to have specific workflow software product know-how in order to customize activity implementations.

The template 14 may be created from scratch using the template editor 12, or the template 14 may be retrieved from a template repository 20 and edited using the template editor 12. Preferably, the apparatus is provided with a template manager 22 that interfaces with the template repository 20 for a user to store a newly created template 14 in the template repository 20, to view existing templates in the template repository 20 and to retrieve a selected template from the template repository 20.

Preferably, editable variables in the template 14 are marked or tagged as being editable when creating the template 14. By marking or tagging variables in a template 14 as being editable, different activity implementations 18 having different variable values can subsequently be readily defined from the same template 14 simply by calling up the marked or tagged variables for editing to enter their appropriate values or required data. Each mark or tag in the template 14 can be accompanied by appropriate description to indicate meaning or usage of the marked or tagged editable variable.

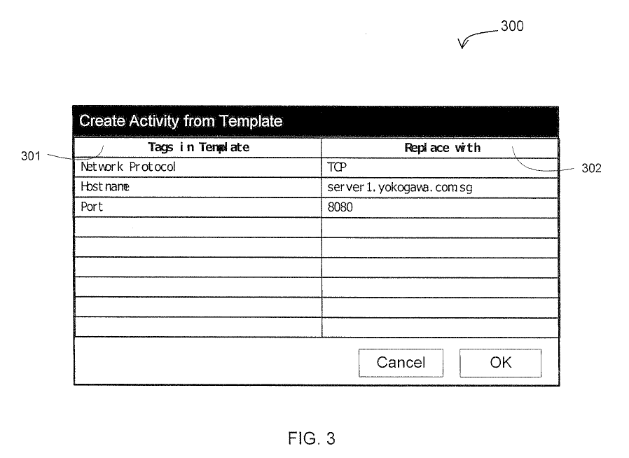

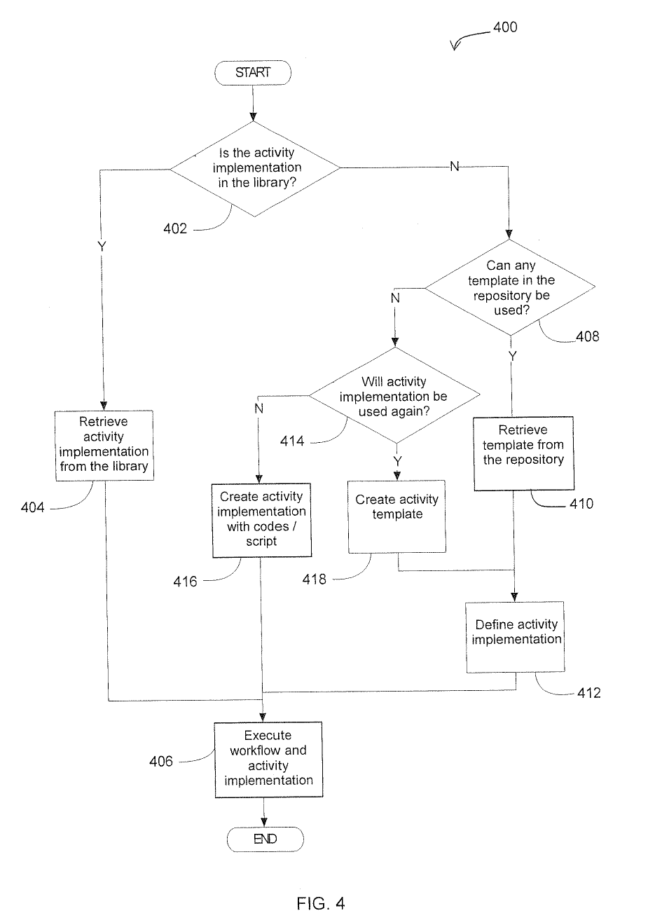

The apparatus 10 therefore preferably also comprises an activity defining module 16 for calling up and defining the marked or tagged editable variables in a template 14 in order to define a specific activity implementation 18 based on the template 14. The activity defining module 16 preferably comprises a graphical user interface 300 as shown in FIG. 3. The graphical user interface 300 preferably includes a dialogue box for a user to replace editable variables 301 in the template with specific variable definitions 302. Any description accompanying each marked or tagged editable variable in the template 14 is preferably displayed in the graphical user interface 300 for a user to know what information is required for each editable variable.

For example, a template 14 for an activity implementation of a specific logic may comprise an editable variable 301 such as “network protocol” in a left column of the dialogue box. For a particular activity implementation having a same specific logic, the activity defining module 16 allows a user to define the variable “network protocol” in the template 14 as “TCP” in a right column of the dialogue box. The apparatus 10 can then define an activity implementation 18 for that particular activity by replacing the editable variables in the template 14 with the information provided by the user through the activity defining module 16. A complete activity implementation 18 therefore comprises computer-readable instructions as provided in the template 14 together with defined variable values as entered through the activity defining module 16.

When the activity implementations 18 for all the activities 102 have been defined, the workflow 100 can then be executed. The apparatus 10 preferably comprises an execution module 24 such as a workflow runtime engine for executing the workflow 100 and performing the associated activity implementations 18 accordingly. The apparatus 10 preferably also comprises an activity implementation library 26 for storing defined activity implementations 18 therein for subsequent use.

Preferably, the apparatus 10 comprises at least one user console 28 through which access to the template editor 12, the activity defining module 16, the template manager 22 and the activity implementation library 26 may be provided.

An exemplary method 400 using the apparatus 10 is shown in FIG. 4. Upon starting, it may be preferred to check whether a desired activity implementation 18 is available and suitable for use in the activity implementation library 26, 402. If yes, the desired activity implementation 18 is retrieved from the library 404 and executed 406 in due time with the workflow using the execution module 24.

If no desired activity implementation 18 is found in the activity implementation library 26, the template repository 20 is checked whether an appropriate template 14 is available and suitable for use 408. If yes, the appropriate template is retrieved from the template repository 20. The desired activity implementation 18 is then defined 412 from the template 14 using the activity defining module 16. The desired activity implementation 18 is then executed 406, as described earlier, and may be stored in the library if it is likely to be used again.

If no appropriate template 14 is found in the template repository 20, it is checked whether the desired activity implementation 18 is likely to be used again 414. If no, the desired activity implementation 18 is preferably created from scratch by writing appropriate codes or script 416 and then executed 406 as described earlier.

If no appropriate template 14 is found in the template repository 20 and the desired activity implementation 18 is likely to be used again, an appropriate template 14 is created 418 using the template editor 12. The created template 14 is preferably stored in the template repository 20. The desired activity implementation 18 is then defined 412 from the created template 14 using the activity defining module 16. The appropriate activity implementation 18 is then executed 406, as described earlier, and is preferably stored in the activity implementation library 26.

By providing the apparatus 10 and method 400 to create templates 14 for activity implementations 18, the burden of writing tedious codes is therefore lightened for developers since new activity implementations 18 may be readily defined from existing appropriate templates 14, simply by defining the editable variables in the templates 14. As a result, a user can build and configure workflows more efficiently. Maintaining workflows is also made easier even as variables of similar activities are changed from time to time or from plant to plant, since existing activity implementations can be easily modified either by directly editing them or by creating new activity implementations using the existing templates 14. As the library of activity implementations increases and as the number of templates in the repository grows, time and effort required to configure workflows are correspondingly reduced.

Whilst there has been described in the foregoing description exemplary embodiments of the present invention, it will be understood by those skilled in the technology concerned that many variations in details of design, construction and/or operation may be made without departing from the present invention. For example, besides allowing new templates to be created or existing templates to be edited, the apparatus and method may also be configured to allow copying of existing templates for subsequent modification in order to create new templates based on existing ones. Other than a dialogue box showing only the editable variables, the activity defining module 16 may also display the computer-readable instructions contained in the template 14. A plurality of user consoles 28 may be provided so that more than one developer may concurrently use the apparatus 10 and method 400 to work on the various activities involved in configuring the workflow.

1. An apparatus for configuring a workflow, the workflow comprising at least one activity, the apparatus comprising:
a template editor for creating or editing a template of an activity implementation for the activity,
wherein the template comprises computer-readable instructions and at least one editable variable.

2. The apparatus of claim 1, further comprising an activity defining module for defining the at least one variable in order to define the activity implementation.

3. The apparatus of claim 1, further comprising a template repository for storing the template therein and for retrieving the template therefrom.

4. The apparatus of claim 3, further comprising a template manager for a user to store a newly created template in the template repository, to view existing templates in the template repository and to retrieve a selected template from the template repository.

5. The apparatus of claim 1, further comprising an execution module for executing the workflow.

6. The apparatus of claim 1, further comprising at least one user console for providing access to the template editor and to the activity defining module.

7. A method of configuring a workflow, the workflow comprising at least one activity, the method comprising:
creating or editing a template of an activity implementation for the at least one activity using a template editor in an apparatus for configuring a workflow,
wherein the template comprising computer-readable instructions and at least one editable variable.

8. The method of claim 7, further comprising checking a template repository in the apparatus for an existing template prior to creating the template.

9. The method of claim 8, further comprising storing the created template in the template repository.

10. The method of claim 8, further comprising checking an activity implementation library in the apparatus for an existing activity implementation prior to checking the template repository.

11. The method of claim 7, further comprising defining the at least one variable using an activity defining module in the apparatus.

12. The method of claim 11, further comprising storing the activity implementation definition in an activity implementation library.

13. The method of claim 11, further comprising executing the workflow using an execution module in the apparatus.

14. The method of claim 11, wherein defining the at least one variable comprises entering an appropriate value for the variable in a dialogue box of the activity defining module.
